(19) United States
(12) Patent Application Publication
(10) Pub. No.: US 2014/0129263 A1
(43) Pub. Date: May 8, 2014

(54) Providing a Virtual Tour

(71) Applicant: Robert Brazell, Salt Lake City, UT (US)

(72) Inventor: Robert Brazell, Salt Lake City, UT (US)

(21) Appl. No.: 13/926,939

(22) Filed: Jun. 25, 2013

Related U.S. Application Data
(60) Provisional application No. 61/721,631, filed on Nov. 2, 2012.

(51) Int. Cl. G06Q 50/12; G06F 3/0482; G06Q 10/02; G06F 3/0481

(52) U.S. Cl. CPC G06Q 50/12; G06F 3/04815; G06F 3/0482; G06Q 10/02
USPC 705/5

(57) ABSTRACT

The present invention extends to methods, systems, and computer program products for providing a virtual tour. A computer system comprising one or more displays arranged circularly can provide an interactive tour of an establishment such as a hotel. The one or more displays can provide a panoramic view of the establishment that updates in response to guest input. In some embodiments, a plurality of displays can be arranged circularly to provide the panoramic view in three dimensions. The panoramic view of the establishment can give the appearance that the guest is walking through the establishment as the guest provides input indicating a desired direction to proceed. One or more of the displays can also provide a touch interface that allows the guest to interact with objects being displayed. In this manner, a guest can tour and explore an establishment from the convenience of a single location.

### CROSS-REFERENCE TO RELATED APPLICATIONS

This application claims the benefit of U.S. Provisional Patent Application No. 61/721,631 which was filed on Nov. 2, 2012.

### BACKGROUND

Some hotels are very large and provide many different types of attractions and amenities. For example, some hotels, in addition to providing guest rooms, restaurants, and business centers, also provide casinos, theaters, night clubs, retail outlets and the like. In such hotels, it can be difficult to know all of the events or activities available at any particular time due to both the number of events and activities as well as the size of the property.

Current approaches for informing guests of attractions, amenities, events, or activities (hereinafter commonly referred to as attractions) include dedicating a television channel to provide information about the attractions available at the hotel, providing a concierge, advertising within the hotel, etc. Each of these approaches has its drawbacks.

For example, a dedicated television channel or an advertisement typically only provides general information to all guests such that each guest views the same content broadcast on the channel or displayed in the advertisement. Although the content can be updated as desired, there is typically no means for customizing the content for a particular guest.

A concierge, on the other hand, can provide information with some level of personalization to a guest. However, to receive personalized information from a concierge, the guest is required to communicate with the concierge which can be an inconvenient way to obtain desired information. For example, this communication can require the guest to visit or call the concierge desk to ask questions. In many cases, the concierge is not immediately available or cannot dedicate the time to fully provide the information desired.

Even if an approach does provide for some level of personalization of the information about the attractions of the hotel, the level of personalization is often limited. For example, a television channel can be configured as a dynamic user interface that allows the guest to select information about an attraction in which the guest is interested. In this way, the guest can select to view only the information he desires to receive. However, the guest is still limited to whatever information is provided by the hotel about the attractions. If the guest desires more information about a particular aspect of an attraction, but the user interface does not provide such information, the guest must resort to other means for obtaining the desired information.

Other types of establishments can present similar problems. For example, it can be difficult to obtain desired information about or to visit certain locations within a museum, a historical site, an office building, a sports arena, a campus, and the like.

### BRIEF SUMMARY

The present invention extends to methods, systems, and computer program products for providing a virtual tour. A computer system comprising one or more displays arranged circularly can provide an interactive tour of an establishment such as a hotel. The one or more displays can provide a panoramic view of the establishment that updates in response to guest input. In some embodiments, a plurality of displays can be arranged circularly to provide the panoramic view in three dimensions similar to a Holodeck.

The computer system can be positioned to allow one or more guests to control the presentation of a virtual tour of an establishment. The panoramic view of the establishment can give the appearance that the guest is walking through the establishment as the guest provides input indicating a desired direction to proceed.

One or more of the displays can also provide a touch interface that allows the guest to interact with objects being displayed. For example, if the guest navigates the panoramic view to a theater box office in a hotel, various objects can be displayed that allow the guest to view upcoming shows as well as to select to purchase tickets to an upcoming show at the theater. Similarly, when a guest navigates to a retail outlet, items for sale in the retail outlet can be displayed as selectable objects to allow the guest to purchase them using the touch interface.

In this manner, a guest can tour and explore an establishment from the convenience of a single location. In some embodiments, a computer system can be provided in a guest room of a hotel. In other embodiments, one or more computer systems can be provided in a public area in or around an establishment. Also, in some embodiments, the computer system can be located remotely from the establishment being toured. In such cases, the guest can tour an establishment without having to travel to the location of the establishment.

In one embodiment, the present invention is implemented as a method for providing a virtual tour to a guest by simultaneously displaying multiple views of a sequence of locations represented in the virtual tour. A plurality of views of a first location represented in a virtual tour is displayed. The plurality of views are displayed on a plurality of displays simultaneously to thereby provide a panoramic view of what would be present at the first location if a guest were physically present at the first location. User input is received from the guest. The user input requests that a plurality of views of a second location be displayed on the plurality of displays. The second location is a next location in the sequence of locations represented in the virtual tour. The plurality of views of the second location is displayed simultaneously on the plurality of displays. The plurality of views of the second location includes one or more guest selectable objects. Input is received from the guest that selects one of the guest selectable objects. In response to the selection of the guest selectable object, an association is created between the guest and the selected guest selectable object.

In another embodiment, the present invention is implemented as a method for providing a virtual tour to a guest by displaying one or more views of a sequence of locations represented in the virtual tour. One or more views of a first location represented in a virtual tour are displayed. The one or more views are displayed on one or more displays simultaneously to thereby provide a view of what would be present at the first location if a guest were physically present at the first location. Input is received from the guest that requests that one or more views of a second location be displayed on the one or more displays. The second location is a next location in the sequence of locations represented in the virtual tour. The one or more views of the second location are displayed simultaneously on the one or more displays. The one or more views of the second location include one or more guest selectable objects that each represents an item at the second location or a service available at the second location. Input is received from the guest that selects one of the guest selectable objects. In response to the selection of the guest selectable object, information is displayed about the item or service represented by the selected guest selectable object.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer system for providing a virtual tour;

FIG. 2 illustrates the computer system of FIG. 1 when it displays multiple views of a room;

FIG. 3 illustrates a flowchart of an example method for providing a virtual tour to a guest by simultaneously displaying multiple views of a sequence of locations represented in the virtual tour; and

FIG. 4 illustrates a flowchart of an example method for providing a virtual tour to a guest by displaying one or more views of a sequence of locations represented in the virtual tour.

### DETAILED DESCRIPTION

The present invention extends to methods, systems, and computer program products for providing a virtual tour. A computer system comprising one or more displays arranged circularly can provide an interactive tour of an establishment such as a hotel. The one or more displays can provide a panoramic view of the establishment that updates in response to guest input. In some embodiments, a plurality of displays can be arranged circularly to provide the panoramic view in three dimensions similar to a Holodeck.

The computer system can be positioned to allow one or more guests to control the presentation of a virtual tour of an establishment. The panoramic view of the establishment can give the appearance that the guest is walking through the establishment as the guest provides input indicating a desired direction to proceed.

One or more of the displays can also provide a touch interface that allows the guest to interact with objects being displayed. For example, if the guest navigates the panoramic view to a theater box office in a hotel, various objects can be displayed that allow the guest to view upcoming shows as well as to select to purchase tickets to an upcoming show at the theater. Similarly, when a guest navigates to a retail outlet, items for sale in the retail outlet can be displayed as selectable objects to allow the guest to purchase them using the touch interface.

In this manner, a guest can tour and explore an establishment from the convenience of a single location. In some embodiments, a computer system can be provided in a guest room of a hotel. In other embodiments, one or more computer systems can be provided in a public area in or around an establishment. Also, in some embodiments, the computer system can be located remotely from the establishment being toured. In such cases, the guest can tour an establishment without having to travel to the location of the establishment.

In one embodiment, the present invention is implemented as a method for providing a virtual tour to a guest by simultaneously displaying multiple views of a sequence of locations represented in the virtual tour. A plurality of views of a first location represented in a virtual tour is displayed. The plurality of views are displayed on a plurality of displays simultaneously to thereby provide a panoramic view of what would be present at the first location if a guest were physically present at the first location. User input is received from the guest. The user input requests that a plurality of views of a second location be displayed on the plurality of displays. The second location is a next location in the sequence of locations represented in the virtual tour. The plurality of views of the second location is displayed simultaneously on the plurality of displays. The plurality of views of the second location includes one or more guest selectable objects. Input is received from the guest that selects one of the guest selectable objects. In response to the selection of the guest selectable object, an association is created between the guest and the selected guest selectable object.

In another embodiment, the present invention is implemented as a method for providing a virtual tour to a guest by displaying one or more views of a sequence of locations represented in the virtual tour. One or more views of a first location represented in a virtual tour are displayed. The one or more views are displayed on one or more displays simultaneously to thereby provide a view of what would be present at the first location if a guest were physically present at the first location. Input is received from the guest that requests that one or more views of a second location be displayed on the one or more displays. The second location is a next location in the sequence of locations represented in the virtual tour. The one or more views of the second location are displayed simultaneously on the one or more displays. The one or more views of the second location include one or more guest selectable objects that each represents an item at the second location or a service available at the second location. Input is received from the guest that selects one of the guest selectable objects. In response to the selection of the guest selectable object, information is displayed about the item or service represented by the selected guest selectable object.

Example Computer Architecture

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

System for Providing a Virtual Tour of a Hotel

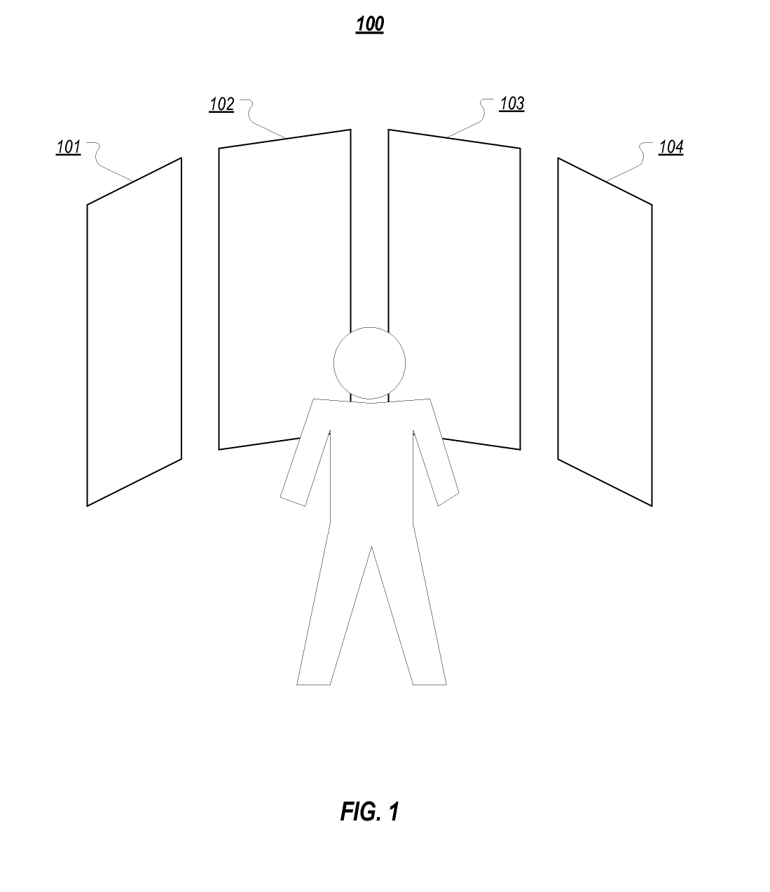

FIG. 1 illustrates an example computer system 100 on which a virtual tour of an establishment can be provided. The following description will use the example of a hotel as the type of establishment for which a virtual tour is provided. However, the computer system of the present invention can be used to provide virtual tours of many other establishments.

Computer system 100 includes a server (not shown) and a plurality of displays 101-104. The server can comprise any combination or arrangement of computing devices that can generate content for display on displays 101-104. The server can be comprised of components separate from displays 101-104, can be incorporated into one or more of displays 101-104, or can include components that are separate from and components that are incorporated into one or more of displays 101-104.

Displays 101-104 are arranged circularly as shown. Although four displays are shown, any number of displays could be used to provide a virtual tour in accordance with the present invention. For example, sufficient displays could be arranged to form a complete circle within which a guest could stand or sit. Similarly, a single display can also be used to provide a virtual tour in accordance with one or more embodiments of the invention.

The server generates the necessary information to display synchronized images on each of displays 101-104 to provide a panoramic view for each location of a virtual tour. For example, when four displays are used, for any given location of a virtual tour, at least four views can exist to allow four corresponding views to be displayed at a time. Referring to FIG. 1 and assuming that 0° represents a line looking straight forward (i.e. a line passing directly between displays 102 and 103), display 101 can display a view representing what would be present between −60° and −30°, display 102 can display a view representing what would be present between −30° and 0°, display 103 can display a view representing what would be present between 0° and 30°, and display 104 can display a view representing what would be present between 30° and 60°.

In some embodiments, the range covered by a view can be adapted to account for any spacing between displays. For example, if the spacing between displays equates to 5° of a view, the view on display 101 can represent −67.5° to −37.5°, display 102 can represent −32.5° to −2.5°, display 103 can represent 2.5° to 32.5°, and display 104 can represent 37.5° to 67.5°.

The particular view that is generated for display on a particular display can be controlled by the server. For example, the server can store a master view of a particular location that is reachable within a virtual tour. The master view can include a number of individual views (e.g. pictures taken at different angles from the same location) or a single combined view that represents a range of what would be present from the location (e.g. a single panoramic picture). The server can identify what direction the guest is looking with respect to the range of what would be present, and generate the individual views that are to be displayed on each display based on this direction and any other information necessary to generate an appropriate view (e.g. information about the width of a display, information about the spacing between displays, information about the number of displays, etc.).

In this way, the server can simultaneously display multiple views that would be visible from a location in the virtual tour. By simultaneously displaying multiple views visible from a given location, a panoramic view is provided that more closely resembles the actual view a guest would see when taking an actual tour through the hotel. In other words, the combination of views displayed on displays 101-104 will give the appearance that the guest is located at the location represented by the views being displayed.

To navigate through a virtual tour, the guest can provide input to the server that causes the server to update which views are being displayed on displays 101-104. For example, the guest can provide input that indicates that the guest desires to move forward (e.g. as if the guest were walking forward from the actual location represented by the views).

As the guest provides input indicating a desired direction to move, the views being displayed on each of displays 101-104 can be updated according to the desired direction of movement. For example, if the guest input indicates a desire to move forward through a hallway, a sequence of views of the hallway can be displayed to give the appearance that the guest is walking down the hallway. Similarly, if the guest input indicates a desire to turn left or right, the views corresponding to a particular location can be shifted in the appropriate direction to give the appearance that the guest is turning.

A guest can provide input to the server to control how the virtual tour is advanced in many different ways. For example, a controller or joystick can be provided to allow the guest to provide input to move or rotate. Also, a speech interface can be employed to allow the guest to speak the direction the virtual tour should proceed.

In this manner, a guest can navigate a hotel via a virtual tour to more easily explore the hotel's attractions. For example, a guest can navigate computer system 100 to take a virtual tour through a hotel to see where a theater, night club, restaurant, retail store, or other attraction is located, and then virtually enter the attraction to continue the tour.

Once an attraction is located within the virtual tour, various items visible in the views can be configured as selected objects to allow the guest to interact with the items. These guest selectable objects can be displayed within the views and can be selectable via a touch or other interface. The type of interaction permitted for each object can depend on the type of item it represents.

For example, when a guest virtually enters a theater on the hotel's premises, the tour can allow the guest to navigate to view the seats within the theater. The seats can be displayed as guest selectable objects thereby allowing the guest to purchase tickets for a particular seat for an upcoming show. In some embodiments, a guest can be given the option to select a particular show, and in response, the seats that are available for the selected show can be displayed as guest selectable objects. Because the virtual tour allows views from particular locations to be displayed, the guest can see the view from a particular seat prior to selecting the seat. For example, the virtual tour can allow the guest to navigate through the theater including between and along rows to identify a particular seat having the most desirable view.

Similarly, when a guest virtually enters a restaurant or night club, the tour can allow the guest to navigate to view the various tables or seats available within the restaurant or night club. Tables or seats that are available for reservation can be displayed as guest selectable objects. The guest can navigate through the virtual tour to or near a desired table or seat and select the table or seat to make a reservation.

The tour can also allow the guest to navigate to view the various items on a menu in a restaurant or night club. For example, each entrée provided at a restaurant can be shown (e.g. on a table), and can be displayed as a guest selectable object to allow the guest to select an entrée to place an order for an upcoming reservation. Similarly, if a restaurant provides a buffet, the virtual tour can allow the guest to navigate around the buffet to see what food items are available.

When a guest virtually enters a spa, the tour can allow the guest to navigate to the rooms within the spa. The virtual tour can also show what services are available within the spa or within a particular room of the spa (e.g. by displaying a guest receiving a massage in one room and a guest receiving a facial in another room). Each room can be configured as a guest selectable object to allow the guest to make a reservation. Similarly, each service provided by the spa or within a particular room can also be represented as a guest selectable object to allow the particular service to be selected. Any type of guest selectable object can be used to represent a service. For example, a massage service can be represented by text or other user interface control that can be selected by the guest. Alternatively, the massage service can be represented by a picture of a guest receiving a massage that is selectable.

Likewise, when a guest virtually enters a retail outlet, the items for sale can be displayed as guest selectable objects thus allowing the guest to purchase an item by touching or otherwise providing input to the guest selectable object. Any items purchased in this manner can be sent to a guest's room or otherwise made available for guest pickup within the hotel. In this way, the guest can virtually visit a hotel's retail outlets (e.g. a gift shop) and purchase items for sale within the retail outlets without having to actually visit the retail outlets. Because the virtual tour provides views of the actual retail outlet (or other attraction), it will appear as if the guest is in fact physically present within the retail outlet.

As another example, when a guest virtually enters a casino, the tour can allow the guest to navigate to each of the games provided in the casino. One or more guest selectable objects can be displayed in association with the games to allow the guest to provide input to a game. For example, a view of a roulette wheel can be provided with guest selectable objects that allow the guest to place a bet. Similarly, a guest selectable object at a game (e.g. blackjack) can allow the guest to make a reservation at a game table.

Accordingly, the computer system of the present invention allows a guest to take a virtual tour of a hotel and all of its attractions to allow the guests to be better informed of what attractions the hotel offers as well as to interact with the attractions from the comfort of a single location. This single location could be the guest's own guest room, a lobby, or other location.

In some cases, it may be more financially feasible to implement computer system 100 within a guest's room using a single display. For example, the television (or another display device) within the guest's room can be used as the display for the virtual tour. In such cases, the server can generate a single view for display on the television and update the view as the guest navigates through the virtual tour. In such cases, the server can generate the single view as a panoramic view to give the appearance that multiple displays are used to display multiple views.

Although the above disclosure uses the example of providing a virtual tour of a hotel, the present invention can be used to give a virtual tour of virtually any establishment or location. For example, a computer system can be configured to provide a virtual tour of a sporting location, a mall, an office building, a historical site, a home, a campus, a city or portion of a city, or any other location where physical tours may be provided. Accordingly, the present invention should not be limited to providing virtual tours of a hotel.

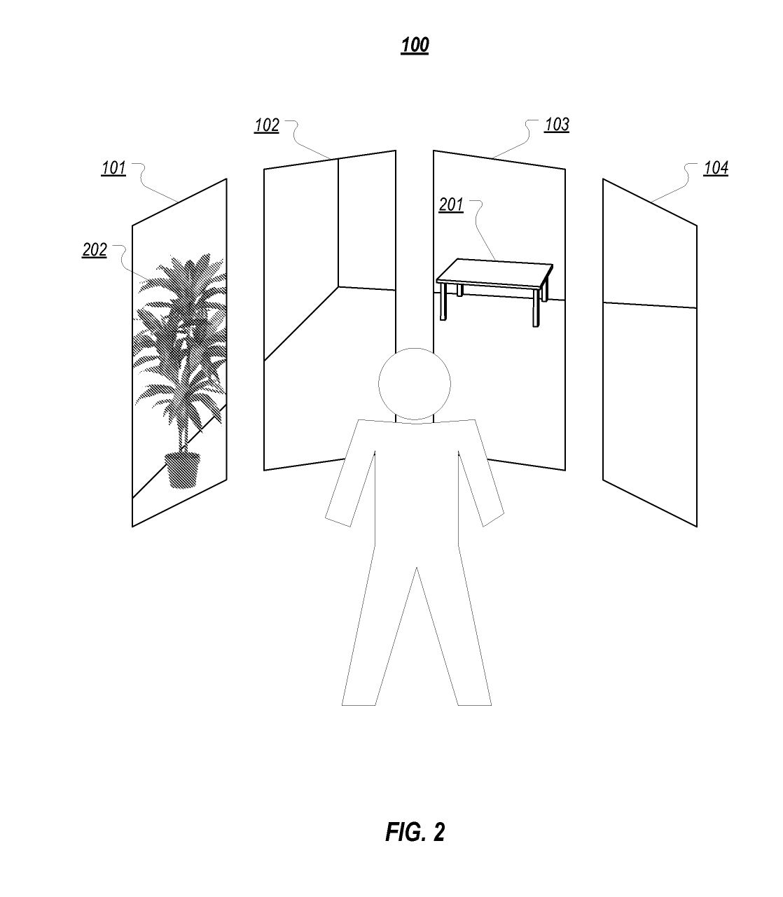

FIG. 2 illustrates an example of computer system 100 when displays 101-104 displays views of a room that contains a table 201 and a plant 202. Table 201 can be displayed as a guest selectable object. For example, table 201 can represent a table in a spa that the guest can select to place a reservation for a massage. Similarly, table 201 can represent a table in a restaurant that the guest can select to place a reservation.

In some embodiments, table 201 as shown in FIG. 2 may not be selectable until the guest has navigated the virtual tour to be within a specified proximity of the table. For example, table 201 may not be selectable in the view shown in display 103 of FIG. 2. However, if the guest navigates the virtual tour to move forward towards table 201, the next view displayed on display 103 may include table 201 as a guest selectable object. In other embodiments, however, an item may be represented by a guest selectable object whenever it is visible within a view.

Example Methods for Providing a Virtual Tour

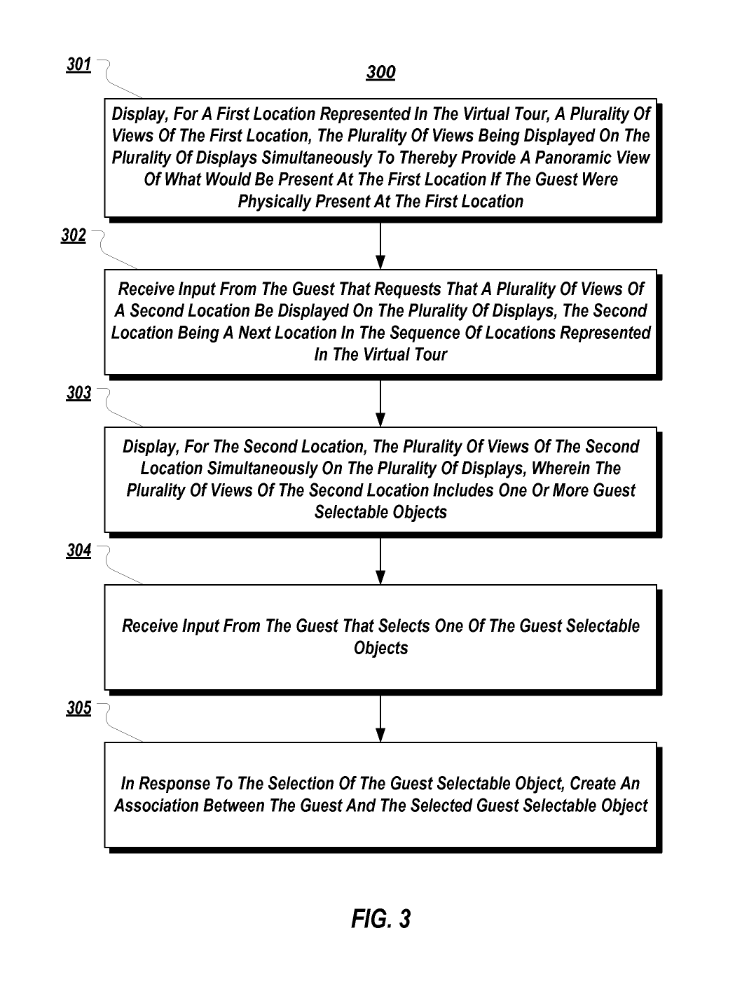

FIG. 3 illustrates a flowchart of an example method 300 for providing a virtual tour to a guest by simultaneously displaying multiple views of a sequence of locations represented in the virtual tour. Method 300 can be implemented in a computer system that includes one or more processors, system memory, and a plurality of displays arranged circularly. Method 300 will be described with reference to FIGS. 1 and 2.

Method 300 includes an act 301 of displaying, for a first location represented in the virtual tour, a plurality of views of the first location, the plurality of views being displayed on the plurality of displays simultaneously to thereby provide a panoramic view of what would be present at the first location if the guest were physically present at the first location. For example, displays 101-104 can each simultaneously display a view of a first location.

Method 300 includes an act 302 of receiving input from the guest that requests that a plurality of views of a second location be displayed on the plurality of displays, the second location being a next location in the sequence of locations represented in the virtual tour. For example, a guest can provide input to computer system 100 that requests that the virtual tour be advanced to a next location.

Method 300 includes an act 303 of displaying, for the second location, the plurality of views of the second location simultaneously on the plurality of displays, wherein the plurality of views of the second location includes one or more guest selectable objects. For example, displays 101-104 can each simultaneously display a view of a second location with the view displayed on display 103 including a table 201 that is displayed as a guest selectable object.

Method 300 includes an act 304 of receiving input from the guest that selects one of the guest selectable objects. For example, the guest can select table 201 by touching table 201 in the view displayed on display 103.

Method 300 includes an act 305 of, in response to the selection of the guest selectable object, creating an association between the guest and the selected guest selectable object. For example, a reservation can be made for the guest for table 201 or for a service provided on or at table 201.

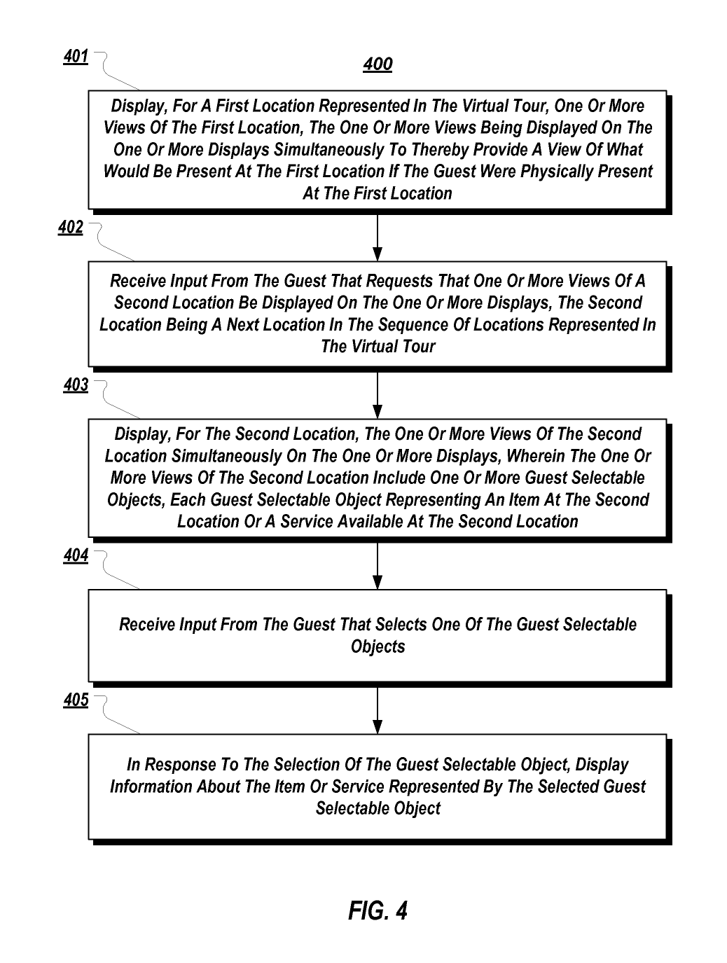

FIG. 4 illustrates a flowchart of an example method 400 for providing a virtual tour to a guest by displaying one or more views of a sequence of locations represented in the virtual tour. Method 400 can be implemented in a computer system that includes one or more processors, system memory, and one or more displays. Method 400 will be described with reference to FIGS. 1 and 2. However, it is to be understood that method 400 can also be implemented in a computer system having a single display.

Method 400 includes an act 401 of displaying, for a first location represented in the virtual tour, one or more views of the first location, the one or more views being displayed on the one or more displays simultaneously to thereby provide a view of what would be present at the first location if the guest were physically present at the first location. For example, displays 101-104 can each simultaneously display a view of a first location.

Method 400 includes an act 402 of receiving input from the guest that requests that one or more views of a second location be displayed on the one or more displays, the second location being a next location in the sequence of locations represented in the virtual tour. For example, a guest can provide input to computer system 100 that requests that the virtual tour be advanced to a next location.

Method 400 includes an act 403 of displaying, for the second location, the one or more views of the second location simultaneously on the one or more displays, wherein the one or more views of the second location include one or more guest selectable objects, each guest selectable object representing an item at the second location or a service available at the second location. For example, displays 101-104 can each simultaneously display a view of a second location with the view displayed on display 103 including a table 201 that is displayed as a guest selectable object.

Method 400 can include an act 404 of receiving input from the guest that selects one of the guest selectable objects. For example, the guest can select table 201 by touching table 201 in the view displayed on display 103.

Method 400 includes an act 405 of, in response to the selection of the guest selectable object, displaying information about the item or service represented by the selected guest selectable object. For example, one or more of displays 101-104 can display information about table 201 such as reservation information, services provided at the table, menu items available at the table, etc.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. In a computer system including one or more processors and system memory, the computer system also including a plurality of displays arranged circularly, a method for providing a virtual tour to a guest by simultaneously displaying multiple views of a sequence of locations represented in the virtual tour, the method comprising:
displaying, for a first location represented in the virtual tour, a plurality of views of the first location, the plurality of views being displayed on the plurality of displays simultaneously to thereby provide a panoramic view of what would be present at the first location if the guest were physically present at the first location;
receiving input from the guest that requests that a plurality of views of a second location be displayed on the plurality of displays, the second location being a next location in the sequence of locations represented in the virtual tour;
displaying, for the second location, the plurality of views of the second location simultaneously on the plurality of displays, wherein the plurality of views of the second location includes one or more guest selectable objects;
receiving input from the guest that selects one of the guest selectable objects; and
in response to the selection of the guest selectable object, creating an association between the guest and the selected guest selectable object.

2. The method of claim 1, wherein the selected guest selectable object comprises an item present at the second location, and wherein creating an association between the guest and the selected guest selectable object comprises purchasing the item for the guest.

3. The method of claim 1, wherein the selected guest selectable object comprises an item present at the second location, and wherein creating an association between the guest and the selected guest selectable object comprises reserving the item for the guest.

4. The method of claim 3, wherein the item is one of a seat or a table.

5. The method of claim 1, wherein the selected guest selectable object comprises an item available at the second location, and wherein creating an association between the guest and the selected guest selectable object comprises ordering the item for the guest.

6. The method of claim 5, wherein the item is a menu item.

7. The method of claim 1, wherein the selected guest selectable object comprises a service available at the second location, and wherein creating an association between the guest and the selected guest selectable object comprises placing a reservation to receive the service at the second location.

8. The method of claim 7, wherein the service comprises a spa service.

9. The method of claim 1, wherein the first location comprises a location within a first establishment, and the second location comprises a location within a second establishment.

10. The method of claim 9, wherein the first establishment is a hotel.

11. The method of claim 1, wherein the first and second location are both within the same establishment.

12. The method of claim 11, wherein the establishment comprises a hotel, a theater, a spa, a restaurant, a casino, an arena, a campus, a house, a historical site, an office building, or a museum.

13. In a computer system including one or more processors and system memory, the computer system also including one or more displays, a method for providing a virtual tour to a guest by displaying one or more views of a sequence of locations represented in the virtual tour, the method comprising:
displaying, for a first location represented in the virtual tour, one or more views of the first location, the one or more views being displayed on the one or more displays simultaneously to thereby provide a view of what would be present at the first location if the guest were physically present at the first location;
receiving input from the guest that requests that one or more views of a second location be displayed on the one or more displays, the second location being a next location in the sequence of locations represented in the virtual tour;
displaying, for the second location, the one or more views of the second location simultaneously on the one or more displays, wherein the one or more views of the second location include one or more guest selectable objects, each guest selectable object representing an item at the second location or a service available at the second location;
receiving input from the guest that selects one of the guest selectable objects; and
in response to the selection of the guest selectable object, displaying information about the item or service represented by the selected guest selectable object.

14. The method of claim 13, wherein the selected guest selectable object represents an item present at the second location.

15. The method of claim 13, wherein the selected guest selectable object represents an item available at the second location.

16. The method of claim 13, wherein the selected guest selectable object represents a service available at the second location.

17. The method of claim 13, further comprising:
creating an association between the guest and the item or service represented by the selected guest selectable object.

18. The method of claim 17, wherein the selected guest selectable object represents an item, and wherein creating an association between the guest and the item comprises purchasing the item.

19. The method of claim 17, wherein creating an association between the guest and the item or service represented by the selected guest selectable object comprises making a reservation for the guest for the item or the service.

20. The method of claim 13, wherein the computer system includes a plurality of displays on which a plurality of views of a location are simultaneously displayed.
